(19) United States
(12) Patent Application Publication
(10) Pub. No.: US 2010/0176698 A1
(43) Pub. Date: Jul. 15, 2010

(54) ELECTRONIC DEVICE

(75) Inventors: Wei Wu, Shenzhen City (CN); Xin Yang, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/641,336

(22) Filed: Dec. 18, 2009

(30) Foreign Application Priority Data
Jan. 14, 2009 (CN) 200910300176.8

(51) Int. Cl. A47B 81/00; E05C 19/16; E05C 19/10; E05C 21/00

(52) U.S. Cl. 312/223.1; 292/251.5; 292/95; 292/1

(57) ABSTRACT

An electronic device includes a body, a cover, and a latch mechanism. The latch mechanism is configured for latching the cover to the body, and unlatching the cover from the body. The latch mechanism includes a fastening portion, and a latching portion. The fastening portion and the latching portion are installed in the cover and the body correspondingly. The fastening portion is operatively engageable with the latching portion for cooperatively latching the cover to the body. When the cover is latched to the body, the latching portion extends out of the cover and engages with the fastening portion, and when the cover is unlatched from the body, the latching portion disengages with the fastening portion and is retracted in the cover.

### BACKGROUND

1. Technical Field

The disclosure relates to latch mechanisms, and more particularly, to a latch mechanism for a portable electronic device.

2. Description of Related Art

A latching apparatus is often arranged in a portable electronic device for latching a cover to a body of the portable electronic device. The latching apparatus often includes a first portion, and a second portion. The first portion and the second portion are fixed to the body or the cover correspondingly. However, when the portable electronic device is in an unlocked state, both the first portion and the second portion extend out of the body or the cover. This is inconvenient and unappealing. Therefore, there is room for improvement in the art.

### BRIEF DESCRIPTION OF THE DRAWINGS

The components of the drawings are not necessarily drawn to scale, the emphasis instead being placed upon clearly illustrating the principles of an electronic device. Moreover, in the drawings, like reference numerals designate corresponding parts throughout several views.

FIG. 1 is a perspective view of an electronic device in accordance with an embodiment, the electronic device includes a body, a cover, and a latch mechanism.

FIG. 2 is an exploded view of the latch mechanism of FIG. 1.

FIG. 3 is a sectional view enlarging III portion of FIG. 2.

FIG. 4 is a cross-sectional view taken along line IV-IV of FIG. 1.

FIG. 5 is a sectional view enlarging V portion of FIG. 2.

FIG. 6 is a sectional view enlarging VI-VI portion in the electronic device shown in FIG. 1.

FIG. 7 is a cross-sectional view taken along line VI-VI of FIG. 1.

### DETAILED DESCRIPTION

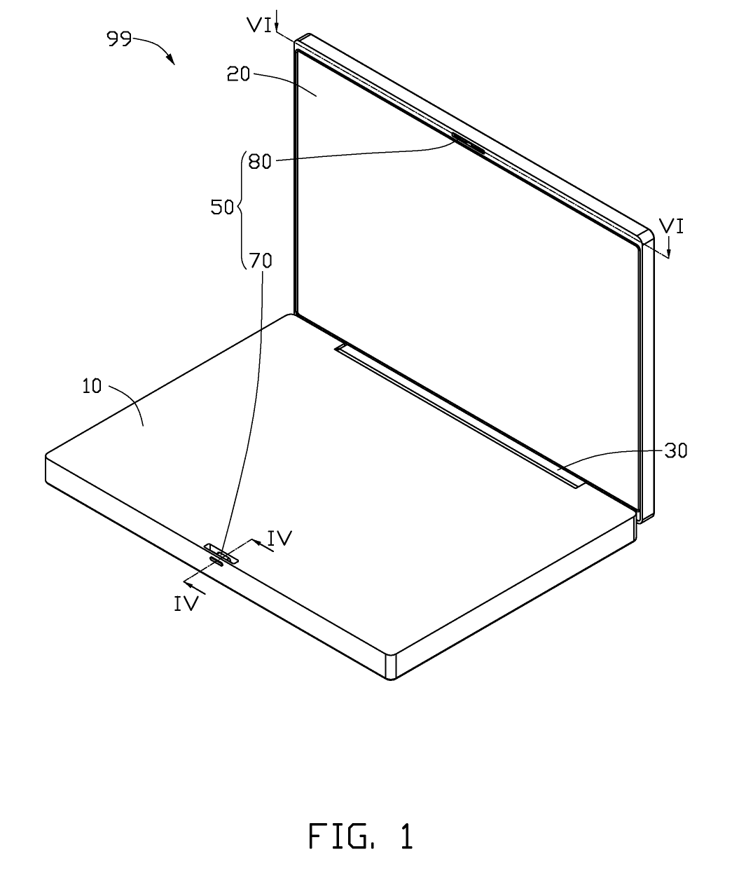

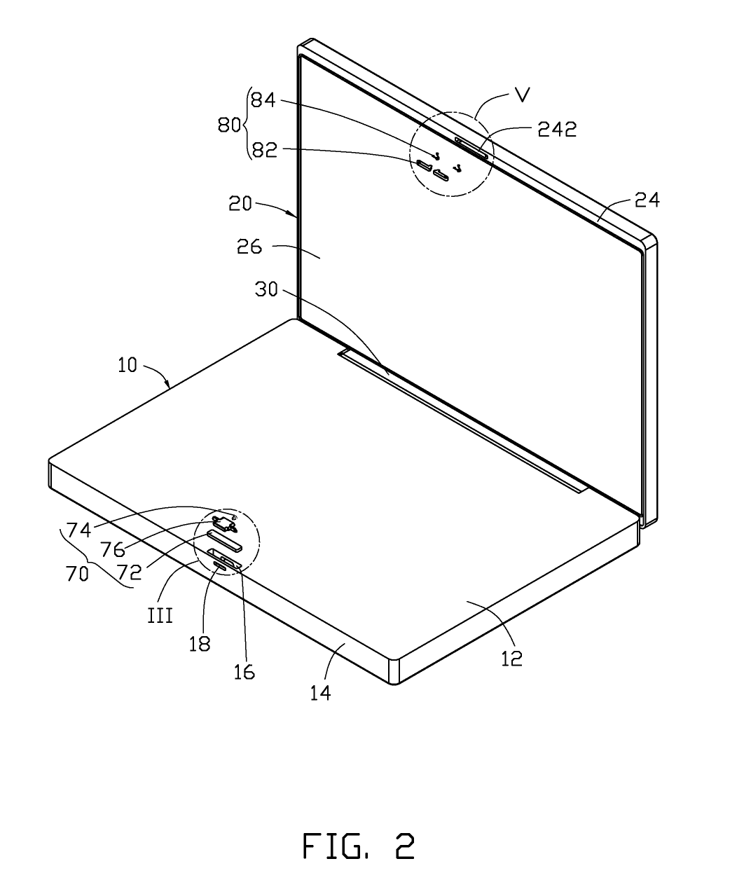

FIGS. 1-4 show an electronic device 99 in accordance with an embodiment of the present invention. The electronic device 99 includes a body 10, a cover 20, a hinge 30, and a latch mechanism 50. The cover 20 is rotatably coupled to the body 10 via the hinge 30. The latch mechanism 50 is configured to latch and unlatch the cover 20 with the body 10. The latch mechanism 50 includes a fastening portion 70, and a latching portion 80. The fastening portion 70 is installed in the body 10. The latching portion 80 is installed in the cover 20. The fastening portion 70 is operatively engageable with the latching portion 80 for cooperatively latching the cover 20 to the body 10. When the electronic device 99 is in an unlocked state, the latching portion 80 is received in the cover 20.

The body 10 is substantially rectangular. The body 10 includes an upper surface 12, and a front sidewall 14. The upper surface 12 is substantially perpendicular to the front sidewall 14. The upper surface 12 defines an elongated recess 16. The elongated recess 16 extends in a direction perpendicular to the upper surface 12 and is adjacent to the front sidewall 14. The front sidewall 14 defines an elongated slot 18 in the middle of the front sidewall 14. The elongated hole 18 extends perpendicularly through the elongated recess 16.

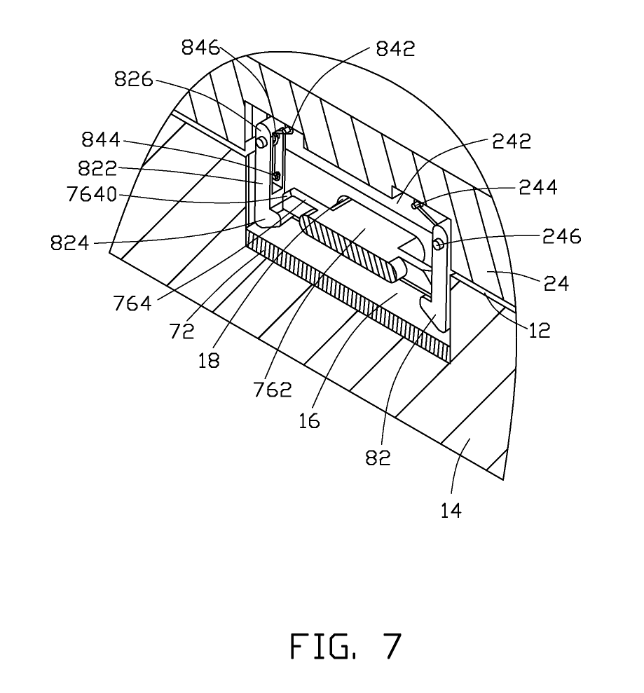

The cover 20 includes an inner surface 24. The inner surface 24 defines an elongated slot 242. The elongated slot 242 is arranged adjacent to a rim of the cover 20 opposite to the hinge 30. When the cover 20 is latched to the body 10, the elongated slot 242 corresponds to the elongated recess 16. Referring also to FIG. 7, two protruding posts 244 and two positioning posts 246 are installed in the elongated slot 242 parallel to each other. The positioning posts 246 are perpendicular to the front sidewall 14 of the body 10 while the cover 20 is latched to the body 10. The two protruding posts 244 are arranged between the two positioning posts 246. The positioning posts 246 are arranged between the protruding posts 244 and the inner surface 24 of the cover 20.

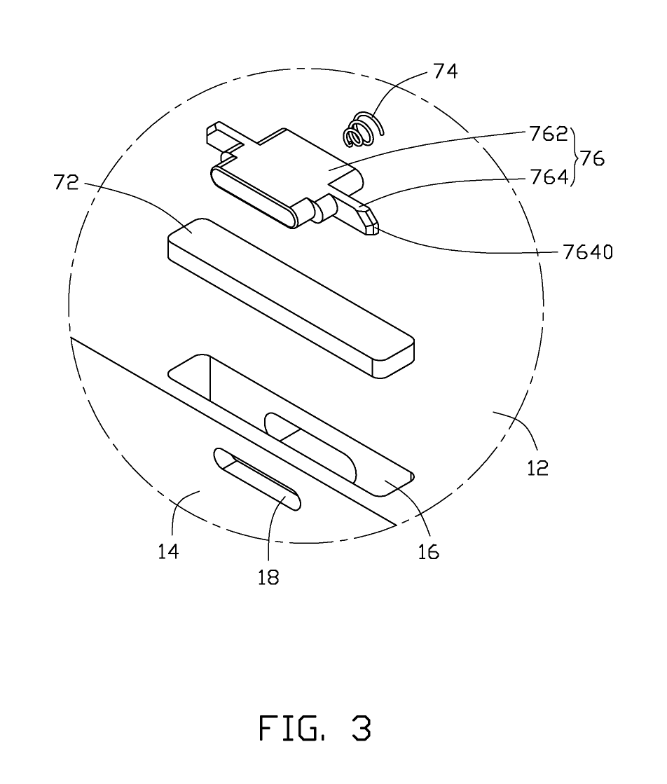

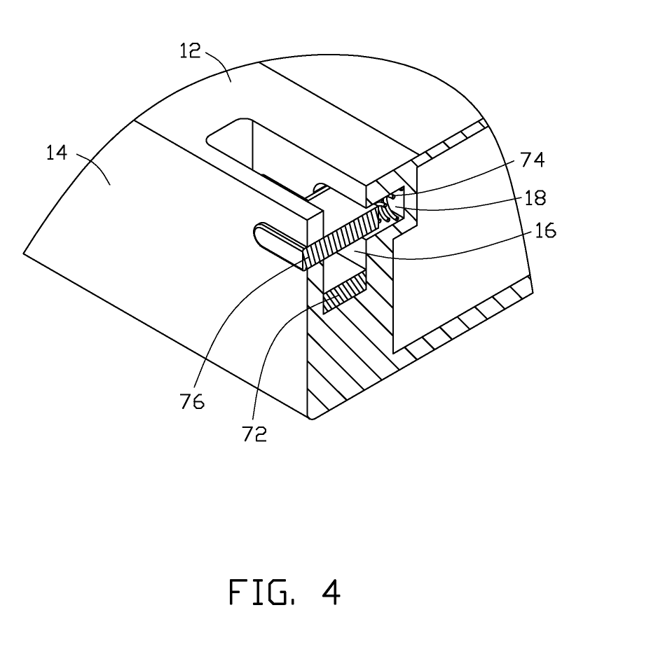

Referring to FIGS. 3-4, the fastening portion 70 includes a magnetic member 72, a first elastic element 74, and an actuating member 76. The magnetic member 72 is substantially rectangular. The magnetic member 72 is installed in the bottom of the elongated recess 16. The actuating member 76 includes a rectangular board 762. The rectangular board 762 is slidable, back and forth, relative to the elongated hole 18. Two protrusions 764 protrude perpendicularly from opposite sides of the actuating member 76. Each protrusion 764 defines an inclined surface 7640. The two protrusions 764 are capable of limiting the rectangular board 762 in the elongated recess 16 and preventing the rectangular board 762 from sliding out of the elongated hole 18. The two protrusions 764 lie in the same plane. The first elastic element 74 is received in the elongated hole 18 and at a predetermined distance from the front sidewall 14. In the embodiment, the first elastic element 74 is a spiral spring. It should be noted that during assembly, the actuating member 76 is received in the elongated hole 18 in a manner such that the protrusions 764 are confined in the elongated recess 16, the first elastic element 74 is confined in the elongated hole 18 and presses the actuating member 76, and the rectangular board 762 partially protrudes out of the elongated hole 18. Thus, when the actuating member 76 is actuated by an external force, the actuating member 76 is driven into the elongated hole 18 pressing the first elastic element 74 to deform. When the actuating member 76 is at rest, the actuating member 76 is driven by the first elastic element 74 to extend out of the elongated hole 18.

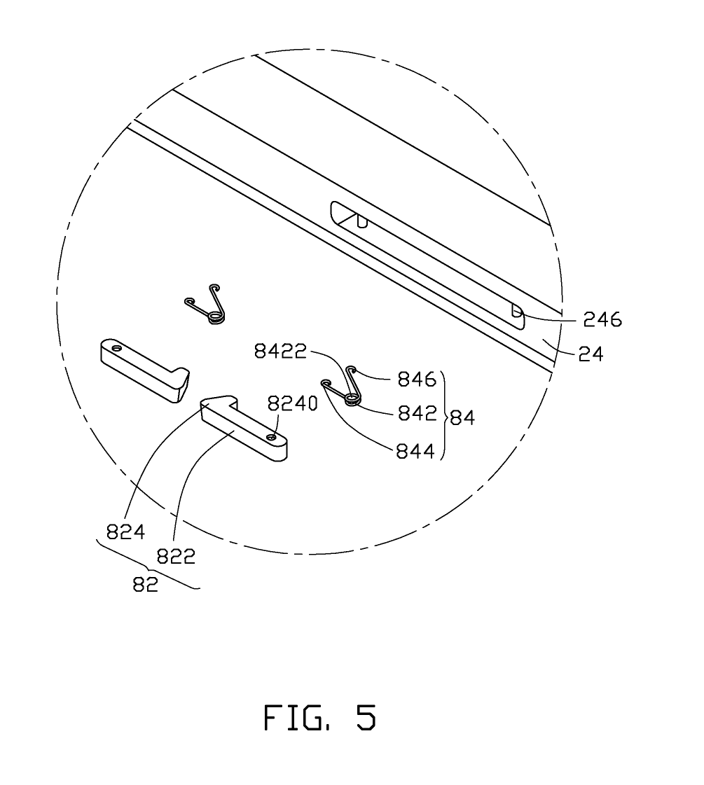

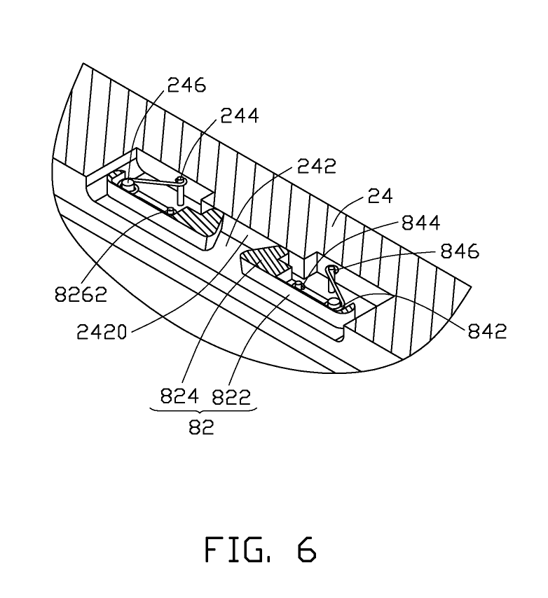

Referring to FIGS. 5-6, the latching portion 80 includes two locking hooks 82, and two second elastic elements 84. The locking hooks 82 are substantially L-shaped. The locking hooks 82 are ferrous or magnetic objects attractable by the magnetic member 72. Each locking hook 82 includes a connecting arm 822, and a latching protrusion 824. The latching protrusion 824 protrudes from the connecting arm 822 to form a hook. The connecting arm 822 defines a through hole 8240 at an end far away from the latching protrusion 824. The through hole 8240 is configured to receive the positioning post 246, whereby the locking hook 82 is rotatably coupled to the positioning post 246. Referring also to FIG. 7, the connecting arm 822 further defines a receiving slot 826. The receiving slot 826 and the latching protrusion 824 are disposed in the same side of the latching portion 80. The through hole 8240 extends through the receiving slot 826. A fixing member 8262 is installed in the receiving slot 826.

The elastic elements 84 are substantially V-shaped. Each elastic element 84 includes a connecting portion 842, a first fixing arm 844, and a second fixing arm 846. The connecting portion 842 connects the first fixing arm 844 with the second fixing arm 846. The connecting portion 842 defines a round hole 8422. The round hole 8422 is configured to receive the positioning post 246, such that the elastic element 84 is rotatably sleeved on the positioning post 246. A tensile force is generated while the first fixing arm 844 and the second fixing arm 846 are splayed. In the embodiment, the spring force is less than the magnetic force generated between the locking hook 82 and the magnetic member 72. In the embodiment, the elastic elements 84 are torsion springs

In assembly, an end of the first fixing arm 844 away from the connecting portion 842 is fastened to the fixing member 8262, the connecting portion 842 is received in the receiving slot 826 in a manner such that the axis of the through hole 8240 and that of the round hole 8422 are aligned in a same line. The positioning post 246 extends through the through hole 8240 and the round hole 8422, such that the locking hook 82 and the elastic element 84 are coupled to the positioning post 246. An end of the second fixing arm 846 is fastened to the protruding post 244.

Referring to FIG. 6, after assembly, when the locking hooks 82 are at rest, the elastic elements 84 drive the locking hooks 82 to resist against an inner sidewall 2420 of the elongated slot 242, thus, the locking hooks 82 are shielded in the elongated slot 242.

Referring to FIG. 7, when the cover 20 rotates toward the body 10, such that the elongated slot 242 is close enough to the elongated recess 16, a magnetic force between the locking hooks 82 and the magnetic member 72 is generated. When the attraction force between the locking hooks 82 and the magnetic member 72 is larger than that of the elastic force of the elastic elements 84, the locking hooks 82 are rotatably repelled away from the inner sidewall 2420 of the elongated slot 242. The locking hooks 82 are then driven by the magnetic member 72 to extend out of the elongated slot 242 and be inserted into the elongated recess 16. When the cover 20 is folded over the body 10, the locking hooks 82 slide along the inclined surfaces 7640 and are latched to the protrusions 764. As a result, the cover 20 is latched to the body 10, and the electronic device 99 is in a locked state.

To unfold the cover 20 away from the body 10, the actuating member 76 is pressed in a direction perpendicular to the front sidewall 14 until the latching protrusions 824 separate from the protrusions 764 so that the cover 20 is unlatched/freed from the body 10. Afterwards the cover 20 is rotated/unfolded away from the body 10, the locking hook 82 is driven to resist against the inner sidewall 2420 of the elongated slot 242 by the spring force of the elastic elements 84, thus, the locking hooks 82 are accommodated and shielded in the elongated slot 242, and the electronic device 99 is in an unlocked state.

Therefore, by operating the latch mechanism 50, the electronic device 99 is changeable between the locked state and the unlocked state, and the latch mechanism 50 is shielded when the electronic device is in the unlocked state.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device, comprising:
a cover;
a body movably coupled to the cover; and
a latch mechanism for latching the cover to the body, wherein the latch mechanism comprises a fastening portion and a latching portion, the fastening portion is associated with one of the cover and the body, the latching portion is associated with the other one of the cover and the body, the fastening portion is operatively engageable with the latching portion for cooperatively latching the cover to the body;
wherein when the cover is latched to the body, the latching portion extends out of the one of the cover and the body, and engages with the fastening portion, and when the cover is unlatched from the body, the latching portion disengages with the fastening portion and is retracted into the one of the cover and the body.

2. The electronic device of claim 1, wherein the fastening portion comprises an actuating member and a magnetic member, the latching portion is capable of being attracted by the magnetic member to extend out of the one of the cover and the body, and the latching portion is capable of being operatively latched to the actuating member after the latching portion extends out of the one of the cover and the body.

3. The electronic device of claim 2, wherein the latching portion comprises a latching hook, and a first elastic element, the latching hook is installed in the one of the cover and the body and is rotatable relative to the one of the cover and the body, a first part of the first elastic element is coupled to the latching hook, a second part of the first elastic element is coupled to the one of the cover and the body.

4. The electronic device of claim 3, wherein the latching hook is attracted by the magnetic member, a magnetic force is generated between the latching hook and the magnetic member when the latching hook and the magnetic member are close enough, the magnetic force is larger than a spring force of the first elastic element.

5. The electronic device of claim 2, wherein the fastening portion further comprises a second elastic element, the second elastic element is sandwiched between the actuating member and the one of the cover and the body in a manner that the second elastic element is elastically stretched in a direction parallel to a direction of the actuating member sliding relative to the one of the cover and the body.

6. The electronic device of claim 2, wherein the latching portion rotates out of the one of the cover and the body when the latching portion is attracted by the magnetic member.

7. An electronic device capable of being changed between an unlocked state and a locked state, the electronic device comprising:
a first electronic member;
a second electronic member rotatably coupled to the first electronic member;
a connecting apparatus for rotatably connecting the first electronic member with the second electronic member; and
a latch mechanism for latching the second electronic member to the first electronic member, and for unlatching the second electronic member from the first electronic member, the latch mechanism comprising a latching portion and a fastening portion, the latching portion capable of being operated to move between a closed position and an open position with respect to the fastening portion;
wherein the fastening portion engages the latching portion in the closed position such that the electronic device is in the locked state and the fastening portion allows the latching portion to move from the closed position such that the electronic device is in the unlocked state.

8. The electronic device of claim 7, wherein when the latching portion engages with the fastening portion in the closed position, and the second electronic member is latched to the first electronic member, whereby the electronic device is in the locked state; and when the latching portion disengages with the fastening portion in the closed position, and the second electronic member is unlatched from the first electronic member, whereby the electronic device is in the unlocked state.

9. The electronic device of claim 7, wherein the fastening portion comprises an actuating member, and a magnetic member, the latching portion is capable of being attracted by the magnetic member to extend out of the second electronic member when the latching portion in the closed position, and the latching portion is capable of being operatively latched to the actuating member after the latching portion extends out of the second electronic member.

10. The electronic device of claim 9, wherein the latching portion includes a latching hook, and a first elastic element, the latching hook is installed in the second electronic member and is rotatable relative to the second electronic member, a first part of the first elastic element is coupled to the latching hook, a second part of the first elastic element is coupled to the second electronic member.

11. The electronic device of claim 10, wherein when the latching portion is in the closed position, the latching hook is attracted by the magnetic member, a magnetic force is generated between the latching hook and the magnetic member, the magnetic force is larger than a spring force of the first elastic element.

12. The electronic device of claim 9, wherein the fastening portion further comprises a second elastic element, the second elastic element is sandwiched between the actuating member and the second electronic member in a manner that the second elastic element is elastically stretched in a direction parallel to a direction of the actuating member sliding relative to the first electronic member.
